(19) United States
(12) Patent Application Publication
(10) Pub. No.: US 2007/0050105 A1
(43) Pub. Date: Mar. 1, 2007

(54) Remote diagnostic data collections for automotive scan tools

(75) Inventors: Manokar Chinnadurai, Owatonna, MN (US); Paul Wempen, Owatonna, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/214,802

(22) Filed: Aug. 31, 2005

(51) Int. Cl. G01M 17/00

(52) U.S. Cl. 701/29; 701/33

(57) ABSTRACT

A computerized method and apparatus for diagnosing an automotive diagnostic computer readable program operable on an automotive diagnostic tool in which the program includes a database of vehicle data. The method comprises providing a first computer system for collecting and storing vehicle data to populate the database. The method also includes establishing communication between the first computer system and a diagnostic tool configured for communication with a vehicle diagnostic system, the diagnostic tool having stored thereon vehicle diagnostic data including a debug file. The debug file can be a log of communication between the automotive diagnostic tool and a vehicle diagnostic system of a vehicle. The debug file preferably includes vehicle data specific to the vehicle. The method further comprises uploading the debug file to the first computer system for including the specific vehicle data in the database to diagnose the program.

### FIELD OF THE INVENTION

The present invention relates generally to the field of automotive diagnostics. More particularly, the present invention relates to methods and products for accessing vehicle data from a remotely located vehicle using a diagnostic tool to collect the data for diagnosing, updating or debugging the diagnostic programs and routines operating on the diagnostic tool.

### BACKGROUND OF THE INVENTION

Historically, diagnostic evaluation of a vehicle control system was performed by using designated, generally stand-alone-type testing equipment that was coupled to the specific vehicle's control system. Vehicle control systems have become more computerized with electronic control units being installed in motor vehicles. These control units include one or more micro-controllers which are used to control operation of a variety of vehicular control systems, such as the engine, transmission, brakes or the steering mechanism systems.

In the automotive industry, there are hand-held diagnostic testers or scan tools used in connection with motor vehicle maintenance and repair. For instance, hand-held diagnostic tools have been used to trouble-shoot faults associated with vehicular control units. Typically such tools have included a micro-processor and an interface circuit to facilitate communication between the vehicle's electronic control unit and the tool's micro-processor.

Each diagnostic tool can also included non-volatile internal or external memory, such as a plug-in module, that stores various vehicle component data to provide information to a user. This vehicle component data can be used or incorporated into diagnostic routines or software programs run by the diagnostic tool to identify vehicles, identify a vehicle's components and provide reference parameters for component performance. In addition, these diagnostic tools can execute diagnostic routines, applications or programs to collect and store diagnostic information such as, for example, trouble codes, sensor data, actuator data or other vehicle diagnostic data from a vehicle's on-board diagnostic (OBD) computer system. The diagnostic programs interpret, process or compare the collected diagnostic information with the stored vehicle data to identify to the user or technician problems associated with the vehicle.

In order for the diagnostic tool to effectively diagnose a wide variety of vehicles, the software operating on the diagnostic tool and the vehicle data it uses are periodically updated to cover model year updates of automobiles. Generally, the software is developed and updated with the vehicle component data and/or diagnostic codes provided by vehicle manufacturers. The software and tool are then tested and verified by the software developers using test vehicles that are made available to the developers. Accordingly, software developers can verify the accuracy of the diagnostic programs by field testing the diagnostic tool. However, a problem arises when specific models of vehicles are not available for testing or are otherwise remote from the developers. Without the ability to test software updates, the developers are unable to verify the accuracy of the program updates.

Another problem arises when technicians or software developers attempt to assist end users of diagnostic tools that are experiencing technical difficulties or errant readings with their tools. Often the tool being used and the car being diagnosed are far from developers, thus making it difficult to correctly identify the problem with the diagnostic tool or the automobile. Moreover, the end user cannot effectively communicate or provide the developer with the necessary data or information to correctly diagnose and correct the problem.

Accordingly, it is desirable to provide a method and apparatus for remotely accessing vehicle diagnostic data from an automotive scan tool in order to either: 1) provide the developers with the necessary information to develop, diagnose, update and/or verify diagnostic software operation on the scan tools; or 2) provide technical support personnel with the necessary information to correctly identify for end users of the diagnostic tool problems with the tool or reasons for apparently errant readings.

### SUMMARY OF THE INVENTION

The foregoing needs are met, to a great extent, by the present invention, wherein in one aspect an apparatus and method is provided that in some embodiments provides for remotely accessing vehicle diagnostic data from an automotive scan tool in order to either: 1) provide the developers with the necessary information to develop, diagnose, update and/or verify diagnostic software operation on the scan tools; or 2) provide technical support personnel with the necessary information to correctly identify for end users of the diagnostic tool problems with the tool or reasons for apparently errant readings.

In accordance with one embodiment of the present invention, a method provides for diagnosing or updating an automotive diagnostic computer readable program operable on an automotive diagnostic tool wherein the program includes a database of vehicle data. The method can comprise providing a first computer system for collecting and storing vehicle data to populate the database and establishing communication between the first computer system and a diagnostic tool configured for communication with a vehicle diagnostic system. The diagnostic tool can have stored thereon vehicle diagnostic data including a debug file. The debug file can be a log of communication between the automotive diagnostic tool and a vehicle on-board diagnostic system of at least one vehicle. The debug file can further including vehicle data specific to the at least one vehicle. The method can further comprise uploading the debug file to the first computer system for including the specific vehicle data in the database to diagnose the program.

In another embodiment, the establishing communication between the first computer and the diagnostic tool can further comprise communicating with a second computer system located remotely relative to the first computer and coupled to the diagnostic tool. The establishing communication further comprising transferring the diagnostic data including the debug file from the diagnostic tool to the second computer system. The uploading the debug file to the first computer system can include uploading the debug file from the second computer system to the first computer system. Moreover, the method can further comprise providing the automotive diagnostic tool and generating the debug file upon communication with the vehicle diagnostic system.

In yet another embodiment according to the present invention, a method provides for debugging an automotive diagnostic tool. The method comprises providing a first computer means configured to store a database of vehicle data files and establishing communication between the first computer means and an automotive diagnostic tool having an errant reading and debug means stored thereon. The debug means can be a log of a communication between the diagnostic tool and at least one vehicle diagnostic system. The method can further comprise uploading the debug means from the diagnostic tool to the first computing system so as to store the debug means on the first computer system for debugging the diagnostic tool.

In another embodiment, the establishing communication between the first computer means and the automotive diagnostic tool can further comprise communicating with a second computer means being located remotely relative to the first computer and coupled to the diagnostic tool and transferring the diagnostic data including the debug means from the diagnostic tool to the second computer means. The uploading the debug file to the first computer means can include uploading the debug means from the second computer means to the first computer means.

In yet another embodiment according to the present invention, a computer product configured for remotely collecting vehicle diagnostic data from an automotive diagnostic tool comprises a computer readable medium having a computer readable program embodied in the storage medium for performing a method. The method can comprise establishing communication between the diagnostic tool and a first computer system, generating a debug file, the debug file being a log of communication between the diagnostic tool and a vehicle diagnostic system of at least one vehicle, and uploading the vehicle debug file from the diagnostic tool to the first computer system so as to remotely collect vehicle diagnostic data on the first computer system. In addition, the method can further comprise establishing communication between the diagnostic tool and a second computer system, uploading the debug file from the diagnostic tool to the second computer system, establishing communication between the first computer system and the second computer system, and uploading the debug file from the second computer system to the first computer system so as to perform the uploading the vehicle debug file from the diagnostic tool to the first computer system and remotely collect the vehicle diagnostic data on the first computer system.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustrative embodiment of a diagnostic data collection system according to the present invention.

FIG. 2 is an illustrative data structure according to an embodiment of the present method.

FIG. 3 is a flowchart of an embodiment of a method according to the present invention.

FIG. 4 is an illustrative block diagram of a computer configured to perform the method of FIG. 3.

FIG. 5 is a flowchart of another embodiment of a method according to the present invention.

FIG. 6 is an illustrative block diagram of an automotive diagnostic tool configured to perform the method of FIG. 5.

### DETAILED DESCRIPTION

An embodiment in accordance with the present invention provides a computerized apparatus and method for remotely diagnosing, updating and/or debugging an automotive scan or diagnostic tool. More specifically, the present invention provides an apparatus and method for updating and/or diagnosing an automotive diagnostic program or application operable on an automotive diagnostic tool. Automotive diagnostic programs operable on the diagnostic tool can include or utilize vehicle data such as, for example, the vehicle component data and/or diagnostic codes. The method according to the present invention can provide for remote collection of such vehicle data using the automotive diagnostic tool. The diagnostic tool can be configured for communication with a vehicle diagnostic system, for example, an OBD system, for collecting and storing a variety of vehicle diagnostic data. The diagnostic tool can further be configured to build and store a debug file which provides a log of communication between the automotive diagnostic tool and a vehicle diagnostic system of a vehicle. The debug file can include vehicle data specific to the vehicle and can be used to generate an update for development and/or diagnosis of the automotive diagnostic programs.

The method can include configuring a first computer system for collecting and storing vehicle data to populate a database for use by or incorporation into the diagnostic program of the diagnostic tool. Further, the method can also include establishing communication between the first computer system and the diagnostic tool. The method can further comprise uploading the debug file from the diagnostic tool to the first computer system so that the specific vehicle data can be stored in the database to diagnose and/or update the program.

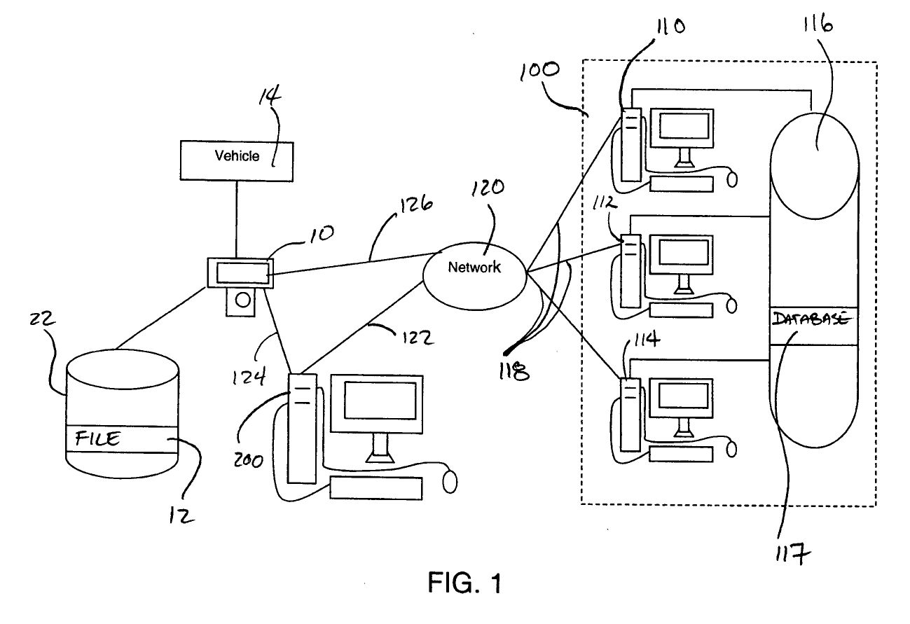

Shown in FIG. 1 is an illustrative automotive diagnostic system for practicing a method according to one embodiment of the invention. The system includes a computer system 100 configured to develop, diagnose and/or troubleshoot diagnostic software applications or programs. The diagnostic applications can be configured to utilize or include vehicle data and run on automotive diagnostic tools, for example, such as diagnostic tool 10. The vehicle data utilized in the applications can include, for example, diagnostic trouble codes, sensor data, vehicle component data or any other vehicle parameter data. The vehicle data can be compiled, for example, in a database 117 and stored in memory storage devices of computer system 100 such as, for example, a server 116. The database 117 can be compiled from vehicle data provided by vehicle manufacturers, OEMs or from data collected during field test as described above. The database 117 can be constructed and maintained so as to associate the vehicle data with specific models and years of vehicle, although other relational databases can be constructed.

The computer system 100 can be of any necessary size to accomplish software development and technical support or troubleshooting capabilities. For example, the computer system 100 can include a single computer work station 110. The computer work station 110 can be constructed so as to have, for example, a processor and storage device for accessing, storing and processing data such as the database of vehicle data. The computer work station 110 can be configured for wired and/or wireless communication over a network, for example, a LAN, WAN or Internet. Alternatively, computer system 100 can include a plurality of computer work stations 110, 112 and 114. As many computer work stations can be added to computer system 100 as is needed for software development. Computer work stations 110, 112 and 114 can be networked and configured for centralized communication via a wired and/or wireless connection to a central server 116.

The central server 116 can be a networked storage device configured to house the database 117 of vehicle data previously described. Each of computer work stations 110, 112 and 114 can access the database 117 stored on central server 116 for developing and troubleshooting the diagnostic software programs. Moreover, each of computers 110, 112 and 114 can be configured for communication outside of the internal network of computer system 100 so as to be able to communicate with remote devices over a network 120 such as, for example, the Internet. Accordingly, computer system 100 can be configured for providing a centralized computer network for software development and technical support.

As indicated in FIG. 1, computer system 100 can be configured for communication with remote computing devices connected to network 120. Specifically, the computer system 100 can be configured, by way of a communication link 118, for communication with one or more remote computer devices connected to the network 120. Shown in FIG. 1 is a computer 200 in communication with computer system 100 over the network 120 via communication link 122. Communication links 118 and 122 can be established by any means and/or combination thereof such as, for example, wired and wireless communication. More specifically computer system 100 and computer 200 can be configured so as to have the necessary ports, drivers, and/or devices for remote dial-up, bulletin board system, TCP/IP or PPP Internet protocol, P2P, wired and/or wireless communication or any combination thereof. The computer 200 can be configured for communication over the network 120, and alternatively or in addition to, the computer 200 can be configured over another network such as, for example, a LAN or WAN. The computer 200 can be, for example, a personal computer (PC), desktop, laptop, or a handheld device.

Referring to FIG. 1, coupled to or in communication with computer 200 over communication link 124 is the diagnostic tool 10. The diagnostic tool 10 can be configured for communication with computer 200 by way of cable connection, for example, using RS-232, USB, fire wire or other cable connection. Alternatively, diagnostic tool 10 can be configured for wireless communication with computer 200 using, IR, IRdA, or other wireless technology. The diagnostic tool 10 can be configured to interface a vehicle diagnostic system 14 of a vehicle using, for example, OBD protocols and interface devices to collect and store vehicle data. The diagnostic tool 10 can be configured to log the communication between the diagnostic tool 10 and the vehicle system 14. The diagnostic tool 10 can store the log of the communication as a debug file 12 in memory 22.

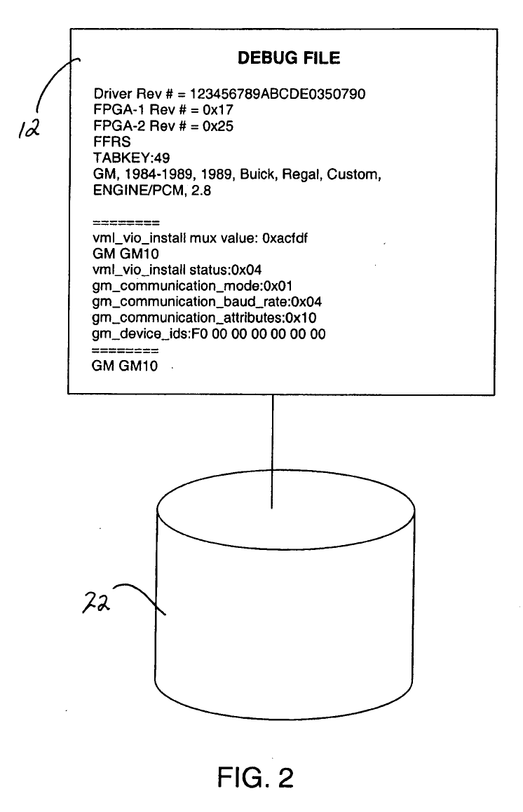

Shown in FIG. 2 is an illustrative structure of the debug file 12. The debug can be generated and configured so as to include specific data regarding the vehicle being tested and its OBD system. More specifically, the debug file can include vehicle data such as, for example, vehicle model, year and type. In addition, the debug file can include specific data regarding the OBD such as for example, data identifying the vehicle system being diagnosed, i.e. engine or brake systems. Moreover the debug file can include information about the communication between the diagnostic tool 10 and the OBD system 14 including the type of communication protocols used. The debug file 12 can further include data about the diagnostic test being performed on the OBD system 14 such as, for example, an actuator diagnostic test, a data stream test, or diagnostic trouble code request, etc. The debug file 12 can be configured so as to be generated automatically or manually. For example, where the debug file 12 is to be generated automatically, the debug file can be configured so as to be generated upon the diagnostic tool 10 establishing communication with the vehicle 14. The debug file can be generated or recorded into memory 22 up to a file size limit such as, for example, 10 kb, so that upon reaching the file size limit, the debug file begins to write-over itself in the memory 22. Alternatively, the debug file 12 can be configured so as to be generated manually, for example, by depressing a button, key or icon of diagnostic tool 10 so as to initiate recordation of the debug file 12 into memory 22.

A method can be embodied in which the diagnostic tool 10, debug file 12, and the computer 200 can provide for remote diagnostic data collection to diagnose, update and/or maintain the database 117 in addition to the diagnostic programs developed by computer system 100. More specifically, the method comprises providing the computer system 100 for collecting and storing vehicle data to maintain, populate or update the database 117. In addition, the method includes establishing communication between the computer system 100 and the diagnostic tool 10 to transfer the debug file 12 over the network 120. More specifically, the method includes transferring the debug file 12 from the diagnostic tool 10 to the computer 200 over communication link 124. The computer 200 can be configured to store the debug file 12. The method can further provide for establishing communication between the computer 200 and computer system 100 via communication links 122 and 118, and uploading the debug file 12 from the computer 200 to the computer system 100 over the network 120; thus providing a method of remote data collection to the computer system 100. The debug file 12 can be accessed and processed by computing system 100 to include or incorporate the specific vehicle data contained in the debug file 12, as previously described, into the database 117 of vehicle data stored on the computer system 100 more specifically stored on the server 116. The database 117 can be accessed to generate a diagnosis of or an update to software programs so as to include, for example, the vehicle data collected from the remote vehicle and its vehicle diagnostic system 14. Alternatively, the developers can further access the database 117 to generate an update solution to correct incomplete or errant readings on the diagnostic tool 10. The software programs and their updates can be provided to end users for updating and/or troubleshooting the programs operating on their diagnostic tools.

In an alternative embodiment of the method according to the present invention, the diagnostic tool 10 can be configured for communication with system 100 to provide for remote diagnostic data collection. More specifically, diagnostic tool 10 can be configured for establishing a direct connection to the network 120 by way of a communication link 126 so as to be in communication with computer system 100 to provide for remote diagnostic data collection. The diagnostic tool 10 can be configured for cable and/or wireless connection to the network 120. More specifically, the diagnostic tool 10 can include the necessary ports, drivers and/or devices for remote dial-up, bulletin board system, TCP/IP or PPP Internet protocol, P2P, wireless communication or any combination thereof. Accordingly, the method can include uploading the debug file directly from the diagnostic tool 10 to the computer system 100. The diagnostic tool 10 can be further configured for performing an upload of the debug file 12 stored on diagnostic tool 10 up to the computer system 100 for use in diagnosing or updating the programs developed or analyzed by the technicians and developers connected to computer system 100.

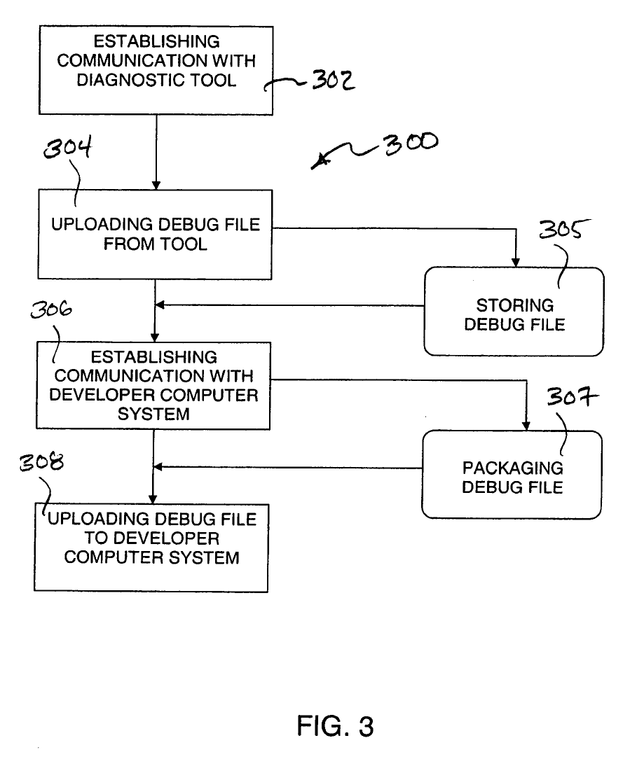

A method according to the present invention can be embodied in a computer readable program or software application. Shown in FIG. 3, is a flow chart showing the functional steps of a computer readable program 300 embodying a method according to the present invention. The computer readable program 300 can be programmed or configured for establishing communication with a diagnostic tool 10 as provided by a communication step 302. The communication step 302 can include generation of the debug file 12, for example, by manually initiating generation of the debug file 12 into memory 22 of the diagnostic tool 10. The program 300 can be further configured to perform a step 304 for uploading the debug file 12 stored on diagnostic tool 10 to, for example, computer 200. Upload of the debug file 12 from diagnostic tool 10 to computer 200 can be implemented by using techniques for accessing a data file stored on one computer memory storage device and uploading it to another. The upload can be by way of cable connection and/or wireless connection of link 124 between the diagnostic tool 10 and the computer 200. The program 300 can further include another communication step 306 for establishing communication with the developer computer system such as, for example, computer system 100. Moreover, the computer program 300 can also include an uploading step 308 to upload the debug file 12 from the computer 200 to the computer system 100. The uploading step 308 can be over communication links 118 and 122 by way of the Internet, telephone/fax, e-mail or any other communication connection previously described. In another embodiment, the program can include a storage step 305 for storing the debug file after uploading the debug file 12 from the diagnostic tool 10 at step 304. In addition, the program can be configured to perform a packaging step 307 for packaging the debug file 12 in a manner necessary for uploading the debug file 12 to the computer system 100 after establishing communication at step 306. For example, the program 300 can package the debug file 12 such that the upload of the debug file 12 is transparent to the user.

The program 300 can also be configured so as to provide a graphical user interface (GUI) or interact with a GUI. For example, the program 300 can provide a user interface with editable entry fields for entry of user input. Moreover, program 300 can include communication features to permit a user to communicate with an engineer or technician on computer system 100. For example, program 300 can provide for instant or e-mail messaging. The program 300 can be implemented in a existing diagnostic tool software configured to run on a computer device such as a PC. Service Solutions of SPX Corporation distributes GENISYS CONNECTECH PC SOFTWARE, an automotive diagnostic software for use with a diagnostic tool such as OTC NEXT GENERATION INFORMATION SYSTEM (NGIS) tool. The software provides application routines with a GUI to facilitate the downloaded, displayed playback or e-mail of vehicle diagnostic data that has been collected and stored on the automotive diagnostic tool 10.

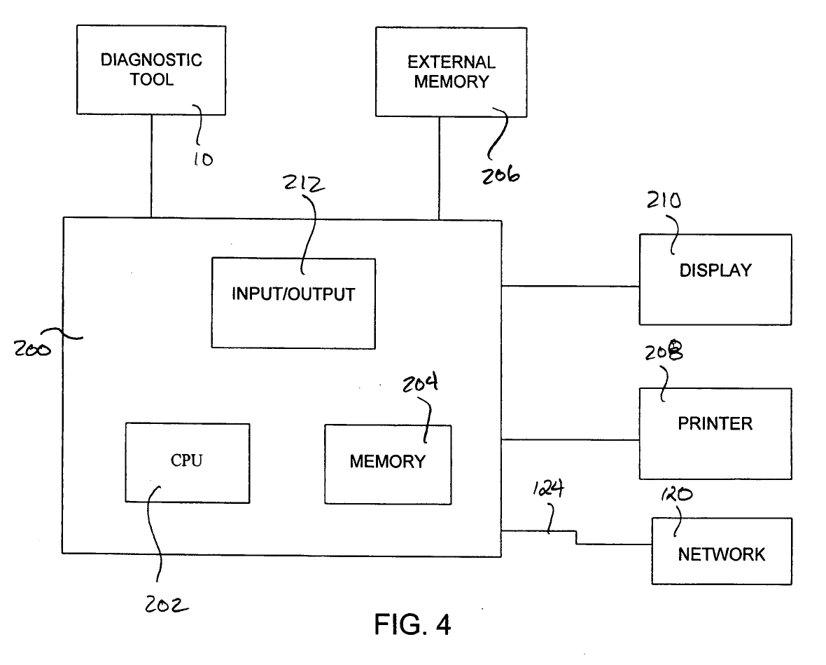

Accordingly, the program 300 can be configured for installation and execution on a computer device such as the computer 200. Shown in FIG. 4 is an illustrative block diagram of computer 200 upon which computer program 300 can be stored. More specifically, the computer 200 can include a processor 202 coupled to or in communication with an internal memory 204 and/or an external memory 206 to execute software applications mounted or installed on computer 200. The computer program 300 can be installed on either of internal memory 204 and external memory 206 for execution by the processor 202. The computer 200 is shown in communication with diagnostic tool 10 and network 120. The computer 200 can include the necessary ports, drivers and/or devices for communication with diagnostic tool 10 and the network 120.

Processor 202 being in communication with internal and external memory 204, 206 can initialize the program 300 stored thereon to perform the method as described above. In executing the program 300, the computer 200 and the computer program 300 can be configured so as to provide an output to a user. For example, the computer program 300 can provide commands to display or print the debug file and/or provide a status of its upload and/or storage. The processor 202, being in communication with a display device 210 and/or a printer device 208, can communicate to the devices 208, 210 to display or printout a status of the debug file upload including contents of the debug file itself. In an alternative embodiment, the computer program 300 can be configured so as to make the method embodied in program 300 transparent to the user. For example, to a user accessing the computer system 100 to troubleshoot the diagnostic tool 10 the generation, the transfer of the debug file 12 may be transparent so as not to disturb the regular scan tool functionality of the diagnostic tool 10. Execution of the program 300 can provide for the processor 202 to instruct presentation of the graphical user interface on display 210. The computer 200 having user input devices 212 such as, for example, a keyboard and mouse can be configured so as to permit a user of computer 200 to communicate with an engineer or technician using computer system 100.

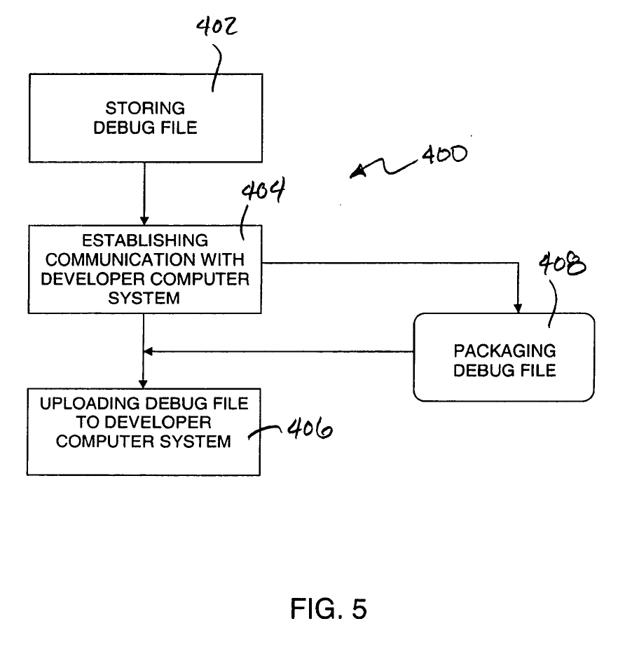

Another embodiment of a method according to the present invention can be embodied in a computer readable program 400 shown as a flow diagram in FIG. 5. The program 400 can provide for direct communication between the diagnostic tool 10 and the computer system 100. More specifically, the method includes a storing step 402 for storing a debug file 12 on diagnostic tool 10. The storing step 402 can include generation of the debug file 12 so as to be constructed in a manner as described above. The program 400 can also include a communication step 404 for establishing communication between the diagnostic tool 10 and the computer system 100. The program can further include an uploading step 406 for uploading the debug file 12 to the computer system 100. The uploading step 406 can be configured so as to be performed by way of cable and/or wireless connection between the diagnostic tool 10 and the computer system 100. The program 400 can also include an alternative step 408 for packaging the debug file so as to include additional information as required for the upload to the computer system 100 in step 400 or otherwise make the upload of the debug file 12 transparent to the user.

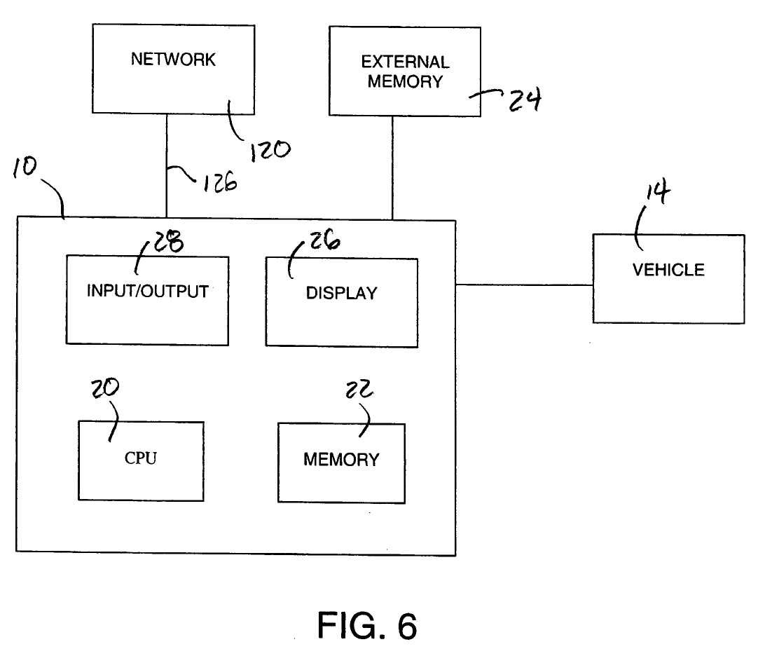

The program 400 can be configured for installation on diagnostic tool 10. Shown in FIG. 6 is an illustrative block diagram showing the functional elements of a diagnostic tool 10 connected to the network 120. The diagnostic tool 10 can be configured for communication with a vehicle diagnostic system 14 for collecting vehicle data to generate a debug file 12. The diagnostic tool 10 can include a processor 20 such as, for example, a MPC823 processor by the Motorola Corporation. The processor can be coupled to or in communication with internal memory 22. The diagnostic tool 10 can be further configured to include an external memory 24 coupled to or in communication with the processor 20.

The processor 20 can be configured to run applications mounted or installed on the diagnostic tool 10. The applications can be downloaded onto the internal memory 22 or alternatively stored on the external memory 24. The internal memory 22 can provide a storage for various applications and drivers such as, for example, boot code, an operating system, diagnostic applications, self-diagnostics, various drivers and space for image data. The external memory 24 can provide storage for program updates or vehicle data as previously described. The program 400 can be installed on either of the internal memory 22 and the external memory 24 to be initialized and executed by the processor 20. Moreover, either of internal memory 22 and external memory 24 can be configured for storing the debug file 12.

The diagnostic tool 10 can also include user interface devices. For example, the diagnostic tool 10 can include a display panel 26 for presenting to the user measured and collected vehicle data. Display panel 26 can be any display panel capable of presenting graphics and/or text. The display panel 26 can be, for example, a liquid crystal display (LCD), a video graphics array (VGA), or touch screen, etc. Diagnostic tool 10 can also include an input/output device 28, for example, buttons or keys that provide a user with the ability to provide a user input or response to prompts issued by various diagnostic applications operable on diagnostic tool 10. Moreover, the input/output device 28 can include the necessary ports, drivers and/or devices for communication with a printer to provide a user with a printout of any diagnostic results or measurements. With the program 400 installed on internal memory 22 or external memory 24, a user can initiate the program 400 from diagnostic tool 10 by way of user interface devices 26, 28. Accordingly, a user can use diagnostic tool 10 to establish communication with the computer system 100 over network 120 to upload the debug file 12 to computer system 100.

In yet another embodiment of the present invention, the program 300 as shown in FIG. 2 can be installed on and executed on the diagnostic tool 10. In such a configuration the program can be run directly from diagnostic tool 10 such that communication with the computer 200 is initiated from diagnostic tool 10 for uploading the debug file 12 from the diagnostic tool 10 to the computer 100. Moreover, the step of uploading the debug file 12 from the computer 200 to the computer system 100 can be initiated from the diagnostic tool 10.

A computer program embodying a method according to the present invention can be recorded and stored a computer readable medium. The medium can be for example, a CD-ROM, flash memory device, network storage device or any combination thereof. The medium can be mounted on either the computer 200 or the diagnostic tool 10 for installation and execution of the program. Alternatively, the program can be executed directly from the medium. The medium can be packaged along with an automotive diagnostic tool 10 so as to form a kit.

An exemplary diagnostic or update operation using the method and system of the present invention is as follows. An end user uses diagnostic tool 10 to run a diagnostic test on, for example, a PATHFINDER, the sports utility vehicle by Nissan Corp. and receives a sensor reading purported to be revolutions per minute (rpm). During the diagnostic test, the diagnostic tool 10 captured and logged a communication with the vehicle and stored the data in a debug file 12. In this example, the rpm reading shown by the diagnostic tool 10 is outside of any expectant range such that the user concludes there is a possible error with the diagnostic tool 10. The user connects the diagnostic tool 10 to a computer 200 having installed thereon the program 300. From the computer system 200, the user initializes the program 300 which establishes communication over the Internet with a computer system 100 of a technical support center. The program 300 accesses the debug file 12 on the diagnostic tool 10 and uploads the debug file 12 to the computer system 100. The debug file 12 can be stored centrally on computer system 100. Technicians or developers access the debug file and discover, for example, that the model and year of the user's vehicle was not available for software verification. Thus, the application on the end user's diagnostic tool 10 did not have the necessary vehicle data and therefore resulted in an errant rpm reading. Using the debug file 12, the developers can generate an update solution and make the solution update available to the user for download. The user can download the solution update and install the update on the diagnostic tool 10 for proper operation.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for diagnosing an automotive diagnostic computer readable program operable on an automotive diagnostic tool wherein the program includes a database of vehicle data, the method comprising:
providing a first computer system for collecting and storing vehicle data to populate the database;
establishing communication between the first computer system and a diagnostic tool configured for communication with a vehicle diagnostic system, the diagnostic tool having stored thereon vehicle diagnostic data including a debug file, the debug file being a log of communication between the automotive diagnostic tool and a vehicle on-board diagnostic system of at least one vehicle, the debug file including vehicle data specific to the at least one vehicle;
uploading the debug file to the first computer system for including the specific vehicle data in the database to diagnose the program.

2. The method of claim 1, wherein establishing communication between the first computer and the diagnostic tool is established over a network.

3. The method of claim 1, wherein establishing communication between the first computer and the diagnostic tool further comprises:
communicating with a second computer system being located remotely relative to the first computer and coupled to the diagnostic tool; and
transferring the diagnostic data including the debug file from the diagnostic tool to the second computer system,
wherein the uploading the debug file to the first computer system includes uploading the debug file from the second computer system to the first computer system.

4. The method of claim 3, wherein the communicating with the second computing system includes providing a computer readable storage medium having stored thereon a computer readable program configured for installation and execution on the second computer system, the program being configured for performing a method comprising:
the establishing communication between the second computer system and the automotive diagnostic tool;
accessing the debug file stored on the diagnostic tool and storing the debug file on the second computer system; and
the uploading the debug file to the first computing system.

5. The method of claim 1, further comprising:
providing the automotive diagnostic tool; and
generating the debug file upon communication with the vehicle diagnostic system.

6. The method of claim 1, further comprising generating the debug file, the generating being performed automatically or manually.

7. The method of claim 1, further comprising accessing and processing the debug file from the first computer system to diagnose the program.

8. A method for debugging an automotive diagnostic tool, the method comprising:
providing a first computer means configured to store a database of vehicle data files;
establishing communication between the first computer means and an automotive diagnostic tool having an errant reading and debug means stored thereon, the debug means being a log of a communication between the diagnostic tool and at least one vehicle diagnostic system;
uploading the debug means from the diagnostic tool to the first computing system so as to store the debug means on the first computer system for debugging the diagnostic tool.

9. The method of claim 8, further comprising processing the debug means including comparing the debug means to the database of vehicle files so as to debug the automotive diagnostic tool.

10. The method of claim 8, wherein the establishing communication between the first computer means and the automotive diagnostic tool occurs remotely over a network.

11. The method of claim 8, wherein the establishing communication between the first computer means and the automotive diagnostic tool further comprises:
communicating with a second computer means being located remotely relative to the first computer and coupled to the diagnostic tool; and
transferring the diagnostic data including the debug means from the diagnostic tool to the second computer means,
wherein the uploading the debug file to the first computer means includes uploading the debug means from the second computer means to the first computer means.

12. The method of claim 8, further comprising:
providing the automotive diagnostic tool; and
generating the debug file upon communication with the vehicle diagnostic system.

13. The method of claim 8 further comprising accessing and processing the debug means from the first computer means to generate a debugging solution for the automotive diagnostic tool.

14. A computer product configured for remotely collecting vehicle diagnostic data from an automotive diagnostic tool, the product comprising:
a computer readable medium having a computer readable program embodied in the storage medium for performing a method comprising:
establishing communication between the diagnostic tool and a first computer system;
generating a debug file, the debug file being a log of communication between the diagnostic tool and a vehicle diagnostic system of at least one vehicle; and
uploading the vehicle debug file from the diagnostic tool to the first computer system so as to remotely collect vehicle diagnostic data on the first computer system.

15. The computer product of claim 14, wherein the computer readable medium is in communication with the automotive diagnostic tool such that the method is executed on the diagnostic tool.

16. The computer product of claim 14, wherein the method further comprises:
establishing communication between the diagnostic tool and a second computer system;
uploading the debug file from the diagnostic tool to the second computer system;
establishing communication between the first computer system and the second computer system; and
uploading the debug file from the second computer system to the first computer system so as to perform the uploading the vehicle debug file from the diagnostic tool to the first computer system and remotely collect the vehicle diagnostic data on the first computer system.

17. The computer product of claim 16, wherein the computer readable medium is in communication with the second computer system such that the method is executed on the second computer system.

18. The computer product of claim 14, wherein the generating the debug file is configured to be performed automatically or manually.

19. The computer product of claim 14, wherein the computer readable medium includes a CD-ROM, flash memory device, network storage device or any combination thereof.

20. The computer product of claim 14, wherein the computer readable medium is packaged with the diagnostic tool so as to form a kit.
